(19) United States
(12) Patent Application Publication
(10) Pub. No.: US 2025/0192477 A1
(43) Pub. Date: Jun. 12, 2025

(54) CONNECTOR CONNECTION STRUCTURE OF VEHICLE

(71) Applicants: Hyundai Motor Company, Seoul (KR); Kia Corporation, Seoul (KR)

(72) Inventors: SuIn Park, Hwaseong-si (KR); Tae Han Kang, Hwaseong-si (KR)

(21) Appl. No.: 18/913,450

(22) Filed: Oct. 11, 2024

(30) Foreign Application Priority Data
Dec. 6, 2023 (KR) 10-2023-0175597

(51) Int. Cl. H01R 13/631

(52) U.S. Cl. CPC H01R 13/631; H01R 2201/26

(57) ABSTRACT

An embodiment power and communication connector connection structure of a vehicle is provided. The vehicle includes a driving module and a space module configured to be coupled to a rear end of the driving module, and the connector connection structure includes a first connector portion disposed on a fixing bar disposed at the rear end of the driving module and protruding toward the space module and a second connector portion disposed on a support of the space module to face the fixing bar and protruding toward the driving module at a part corresponding to the first connector portion and configured to be coupled to or separated from the first connector portion.

### CROSS-REFERENCE TO RELATED APPLICATIONS

This application claims the benefit of Korean Patent Application No. 10-2023-0175597, filed on Dec. 6, 2023, which application is hereby incorporated herein by reference.

### TECHNICAL FIELD

The present disclosure relates to a connector connection structure of a vehicle.

### BACKGROUND

Recently, the automobile industry has been introducing a new concept of future mobility vision to realize a human-centered and dynamic future city. One of these future mobility solutions is a purpose built vehicle (PBV), which is a purpose-based mobility vehicle.

An example of the PBV may include an eco-friendly mobile vehicle based on an electric vehicle (EV). The PBV may provide users with various customized services during a travel time from the departure to the destination through unmanned or manned autonomous driving.

Such a PBV may include a cab type driving module that employs a driving module and is capable of autonomous driving and a space module that is coupled to the driving module and is used for cargo transportation, passenger use, home office, etc.

Power and communication connectors applied to the driving module and the space module are mainly connected manually. This method is used for an operator to manually connect a connector provided on the driving module to the space module, which makes it difficult to use in an automatic connection and disconnection method of a future mobility. In addition, before connecting the driving module and the space module, the connector and a connector connection part are exposed to the outside, which causes foreign substances to enter or contamination to occur.

### SUMMARY

The present disclosure relates to a connector connection structure of a vehicle. Particular embodiments relate to a power and communication connector connection structure of a vehicle body including a driving module (fixing portion) and a space module (varying portion) in a PBV.

Embodiments of the present disclosure provide a connector connection structure of a vehicle capable of automatically connecting a power and communication connector at a correct position when connecting a driving module and a space module and protecting the connector and a connector connection part from external contamination when disconnecting the driving module and the space module.

A power and communication connector connection structure of a vehicle including a driving module and a space module coupled to a rear end of the driving module according to an embodiment of the present disclosure includes a first connector portion formed on a fixing bar provided at the rear end of the driving module and protruding toward the space module and a second connector portion formed on a support of the space module disposed to face the fixing bar and protruding toward the driving module at a part corresponding to the first connector portion to be coupled to or separated from the first connector portion.

The first connector portion may include a driving module connector recessed into the fixing bar, having one end connected to an inside of the driving module and the other end protruding toward the space module, a connection auxiliary device disposed outside the fixing bar in a direction toward the space module and configured to operate to cover or uncover the other end of the driving module connector at an outer peripheral part of the other end of the driving module connector, and an actuator disposed on a side portion of the connection auxiliary device outside the fixing bar and configured to apply pressure through contact with the connection auxiliary device and operate the connection auxiliary device.

The second connector portion may include a space module connector recessed into the support, having one end connected to an inside of the space module and the other end protruding toward the driving module, and a connection groove formed in an outer peripheral surface of a protruding part of the space module connector and into which an end of the connection auxiliary device is inserted and fixed.

The driving module connector may be configured as a female-type (F-type) connector, the space module connector may be configured as a male-type (M-type) connector, and the driving module connector and the space module connector may be formed in a cylindrical shape.

The connection auxiliary device may be formed as a plurality of plates arranged along a circumference of the outer peripheral part of the other end of the driving module connector, and the plurality of plates may be arranged so that side portions thereof overlap each other and operate in series at the same time.

The plurality of plates may be formed in a concave shape toward the second connector portion.

The plurality of plates may be provided so that one end thereof hinges and rotates around an axis that is a direction perpendicular to a longitudinal direction of the vehicle body at the outer peripheral part of the other end of the driving module connector.

A center part of the one end of the plurality of plates may be connected to a hinge member and hinge and rotate.

On both sides of the hinge member of the fixing bar, elastic members providing an elastic force may be provided such that the plurality of plates are unfolded.

The plurality of plates may hinge and rotate so that the other end thereof has an operating range from a range greater than a thickness of the space module connector to a range that completely covers the driving module connector.

In a standby state where the driving module and the space module are not coupled to each other, the actuator may be in contact with and apply pressure to the connection auxiliary device to operate such that the connection auxiliary device completely covers the other end of the driving module connector.

When the first connector portion is connected to the second connector portion, the actuator may be in contact with and apply pressure to the connection auxiliary device to operate such that the end of the connection auxiliary device is inserted into the connection groove.

According to an embodiment of the present disclosure, the connector connection structure of the vehicle may automatically connect a power and communication connector at a correct position when connecting a driving module and a space module and protect the connector and a connector connection part from external contamination when disconnecting the driving module and the space module.

In addition, the connector connection structure of the vehicle may be widely employed not only for coupling PBVs, but also for connecting trailers and towing vehicles, and applied from a manual method to an automatic method, and thus, marketability may be improved.

### BRIEF DESCRIPTION OF THE DRAWINGS

FIG. 1 is a diagram schematically showing a vehicle to which a connector connection structure of the vehicle is applied according to an embodiment of the present disclosure.

FIG. 2 is a diagram schematically showing a connector connection relationship of ‘A’ part of FIG. 1.

FIG. 3A is a diagram schematically showing a state before connecting of the connector connection structure of the vehicle according to an embodiment of the present disclosure.

FIG. 3B is a diagram schematically showing a state during connecting of the connector connection structure of the vehicle according to an embodiment of the present disclosure.

FIG. 3C is a diagram schematically showing a state after complete connecting of the connector connection structure of the vehicle according to an embodiment of the present disclosure.

FIG. 4A is a diagram showing a state in which a first connector portion of the connector connection structure of the vehicle completely covers a driving module connector according to an embodiment of the present disclosure.

FIG. 4B is a diagram showing a state in which the first connector portion of the connector connection structure of the vehicle exposes the driving module connector according to an embodiment of the present disclosure.

FIG. 4C is a diagram showing a state in which the first connector portion and a second connector portion of the connector connection structure of the vehicle are being connected according to an embodiment of the present disclosure.

FIG. 4D is a diagram showing a state in which the first connector portion and the second connector portion of the connector connection structure of the vehicle are completely connected according to an embodiment of the present disclosure.

FIG. 5 is an enlarged view of the first connector portion of the connector connection structure of the vehicle according to an embodiment of the present disclosure.

FIG. 6A is a diagram showing an example of a connection error in the connector connection structure of the vehicle according to an embodiment of the present disclosure.

FIG. 6B is a diagram showing another example of a connection error in the connector connection structure of the vehicle according to an embodiment of the present disclosure.

FIG. 6C is a diagram showing an example of a normal connection of the connector connection structure of the vehicle according to an embodiment of the present disclosure.

### DETAILED DESCRIPTION OF ILLUSTRATIVE EMBODIMENTS

Embodiments of the present disclosure will be described more fully hereinafter with reference to the accompanying drawings, so that those skilled in the art to which the present disclosure pertains may easily implement the embodiments of the present disclosure. However, the present disclosure may be implemented in many different forms and is not limited to the embodiments described herein.

In addition, in various embodiments, elements having the same configuration are typically described in a first embodiment by using the same reference numerals, and in other embodiments, only configurations different from the first embodiment will be described.

Please be informed that the drawings are schematic and not drawn to scale. Relative dimensions and ratios of parts in the drawings are shown exaggerated or reduced in size for clarity and convenience in the drawings, and any dimensions are illustrative only and not limiting. In addition, the same reference numerals are used to denote similar features in the same structure, element, or parts appearing in two or more drawings. When an element is referred to as being “on” another element, it may be directly on the other element or intervening elements may also be accompanied.

The embodiments of the present disclosure specifically represent exemplary embodiments of the present disclosure. As a result, various modifications of diagrams are expected. Therefore, the embodiments are not limited to a specific shape of an area shown, and include, for example, a modification of the shape by manufacturing.

Hereinafter, a connector connection structure of a vehicle according to embodiments of the present disclosure will be described in detail with reference to the accompanying drawings.

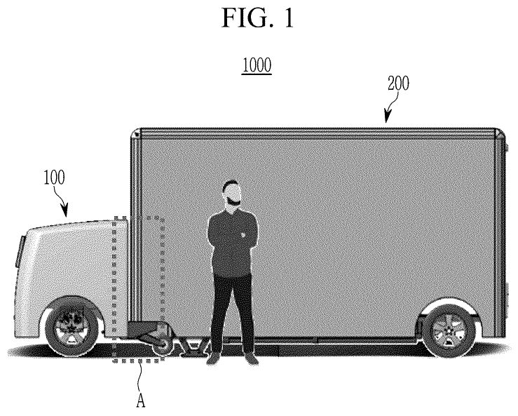

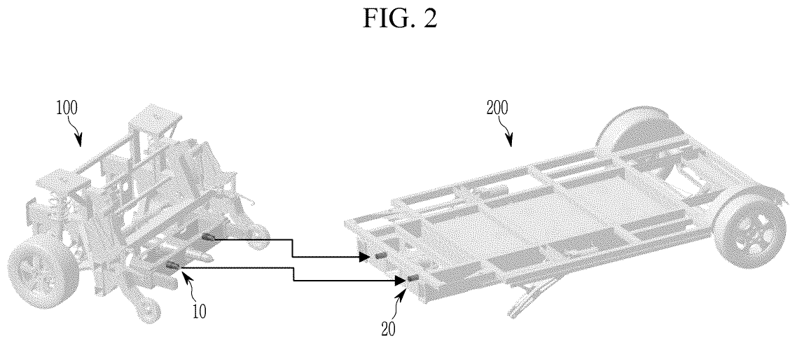

FIG. 1 is a diagram schematically showing a vehicle to which a connector connection structure of the vehicle is applied according to an embodiment of the present disclosure. FIG. 2 is a diagram schematically showing a connector connection relationship of ‘A’ part of FIG. 1.

Referring to FIGS. 1 and 2, the connector connection structure of the vehicle according to an embodiment of the present disclosure may be applied to, for example, a purpose built vehicle (hereinafter referred to as a ‘PBV’).

The PBV may be used as an electric vehicle-based life module vehicle that provides various customized services to users during a travel time from the departure to the destination.

A vehicle body of such a PBV is suitable for small quantity production of various vehicle models with a small number of parts and may be manufactured in various shapes and sizes.

In an embodiment of the present disclosure, a vehicle 1000 may include a cab type driving module 100 and one box type space module 200 coupled to the rear of the driving module 100.

The connector connection structure of the vehicle according to an embodiment of the present disclosure may be a power and communication connector connection structure of the vehicle 1000 achieved by coupling a first connector portion 10 disposed at a rear end of the driving module 100 and a second connector portion 20 disposed at a front end of the space module 200 coupled to the rear end of the driving module 100.

In addition, the connector connection structure of the vehicle according to an embodiment of the present disclosure may automatically couple the first connector portion 10 to the second connector portion 20 when the driving module 100 moves backward and is coupled to the space module 200 while the space module 200 is stopped.

Meanwhile, embodiments of the present disclosure may be applied not only to a PBV configured by coupling the driving module 100 and the space module 200, but also to a connection method of a tow vehicle and a trailer.

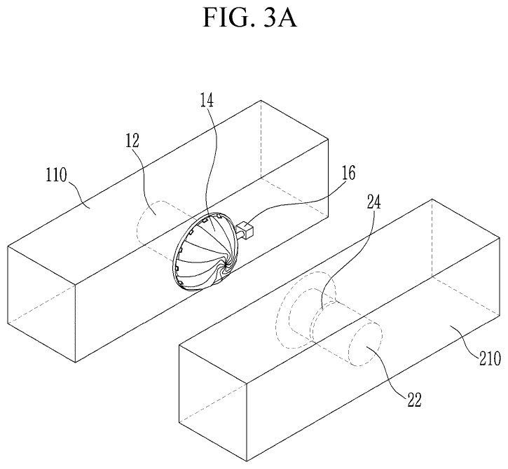

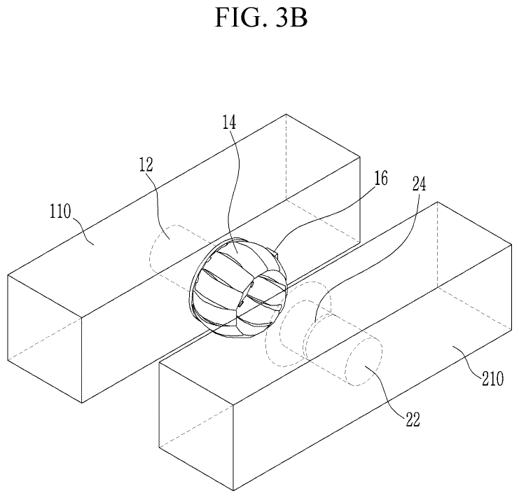

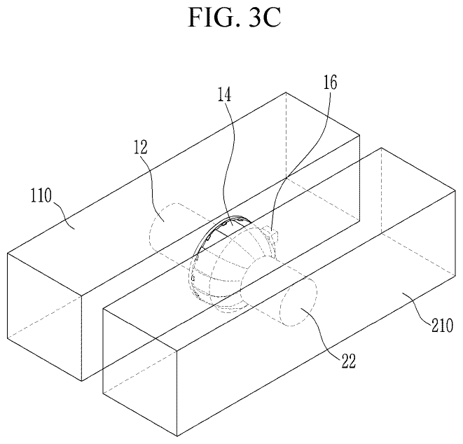

FIG. 3A is a diagram schematically showing a state before connecting of the connector connection structure of the vehicle according to an embodiment of the present disclosure. FIG. 3B is a diagram schematically showing a state during connecting of the connector connection structure of the vehicle according to an embodiment of the present disclosure. FIG. 3C is a diagram schematically showing a state after complete connecting of the connector connection structure of the vehicle according to an embodiment of the present disclosure.

Referring to FIGS. 3A to 3C, the connector connection structure of the vehicle according to an embodiment of the present disclosure may be formed by coupling the first connector portion 10 and the second connector portion 20.

The first connector portion 10 is formed on a fixing bar 110 provided at a rear end of the driving module 100 and protrudes toward the space module 200 in a longitudinal direction of the vehicle 1000.

The fixing bar 110 may constitute the rear end of the driving module 100 and, in the form of a rectangular bar extending in a direction perpendicular to the longitudinal direction of a vehicle body, serve as a framework of a coupling part of the driving module 100. A guide pin that protrudes toward the space module 200 may be provided in a center part of the fixing bar 110.

Extension pins may be provided in the form of protruding toward the space module 200 from an edge part of the fixing bar 110. The extension pins may be provided in the form of a rectangular bar and may be provided as a pair at the edge part of the fixing bar 110.

The first connector portion 10 may be provided on the fixing bar 110 on both sides of the guide pin, one each between the guide pin and the extension pins.

In addition, the second connector portion 20 is formed on a support 210 of the space module 200 disposed to face the fixing bar 110 and is in the form of protruding toward the driving module 100 in a longitudinal direction of the vehicle 1000 at a part corresponding to the first connector portion 10.

A guide slot into which the guide pin is inserted may be formed in a center part of the support 210 of the space module 200 upon coupling of the driving module 100 and the space module 200. In addition, a pair of extension slots into which the extension pins are inserted may be provided at an edge part of the support 210.

The second connector portion 20 may be provided on the support 210 one each between the guide slot and the extension slots.

Therefore, upon coupling of the driving module 100 and the space module 200, the guide pin and the guide slot may be connected, the extension pins and the extension slots may be connected, and the first connector portion 10 and the second connector portion 20 may be connected.

The first connector portion 10 includes a driving module connector 12, a connection auxiliary device 14, and an actuator 16.

The driving module connector 12 may be recessed into the fixing bar 110 and formed in a cylindrical shape. In addition, the driving module connector 12 may be a female-type (F-type) connector.

One end of the driving module connector 12 may be connected to the inside of the driving module 100, and the other end thereof may protrude toward the space module 200.

The connection auxiliary device 14 may be disposed outside the fixing bar 110 in a direction toward the space module 200 and operate to cover or uncover the other end of the driving module connector 12 at an outer peripheral part of the other end of the driving module connector 12. For example, the connection auxiliary device 14 may be formed as, for example, a plurality of wing members that are connected to each other, partially overlap, and operate in series.

The actuator 16 may be disposed on a side portion of the connection auxiliary device 14 outside the fixing bar 110 and operate the connection auxiliary device 14 by applying pressure due to a contact with the connection auxiliary device 14.

The second connector portion 20 includes a space module connector 22 and a connection groove 24.

The space module connector 22 may be recessed into the support 210 and formed in a cylindrical shape. In addition, the space module connector 22 may be a male-type (M-type) connector.

One end of the space module connector 22 may be connected to the inside of the space module 200, and the other end thereof may protrude toward the driving module 100.

The connection groove 24 may be formed in an outer peripheral surface of a protruding part of the space module connector 22 and fixed by inserting an end of the connection auxiliary device 14 thereinto.

In a state where the driving module connector 12 and the space module connector 22 are in contact with and coupled to each other, the connection auxiliary device 14 is pressured by the actuator 16 such that the connection groove 24 is integrally formed in an outer circumference of the space module connector 22 at a position where the other end of the connection auxiliary device 14 is in contact with the space module connector 22. That is, in the state where the driving module connector 12 and the space module connector 22 are in contact with and coupled to each other, the other end of the connection auxiliary device 14 may be inserted into the connection groove 24 to maintain a coupling state.

As shown in FIG. 3A, in a standby state where the driving module 100 and the space module 200 are not coupled, the actuator 16 is in contact with and applies pressure to a side portion of the connection auxiliary device 14 to remain folded such that the connection auxiliary device 14 completely covers the other end of the driving module connector 12. The actuator 16 may include a bar that moves back and forth to make or release contact with the side portion of the connection auxiliary device 14.

As shown in FIG. 3B, when the driving module 100 moves backward and approaches the space module 200, the actuator 16 operates to release the pressure applied to the connection auxiliary device 14. In this case, the connection auxiliary device 14 unfolds by an elastic force, and the other end of the driving module connector 12 is exposed.

As shown in FIG. 3C, when the driving module 100 and the space module 200 are coupled to each other, the driving module connector 12 and the space module connector 22 are coupled to each other, and the actuator 16 operates to be in contact with and apply pressure to the side portion of the connection auxiliary device 14. The other end of the connection auxiliary device 14 is inserted into and coupled to the connection groove 24 formed in the space module connector 22.

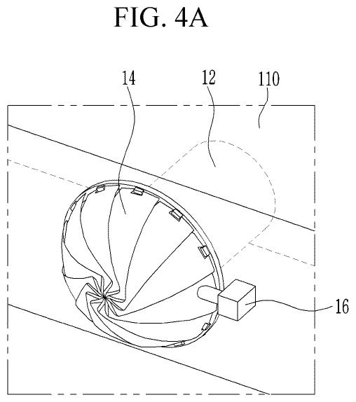

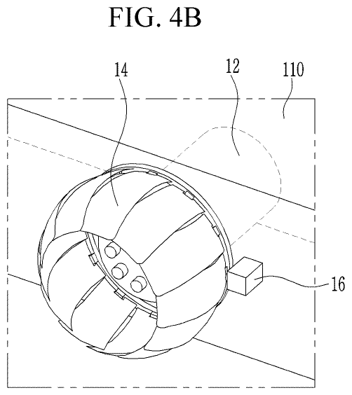

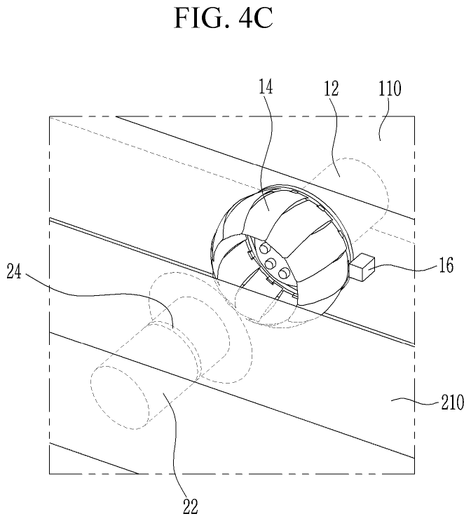

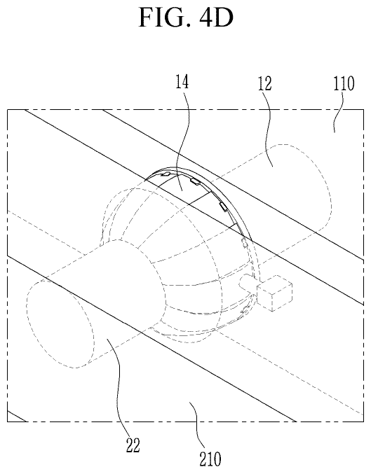

FIG. 4A is a diagram showing a state in which a first connector portion of the connector connection structure of the vehicle completely covers a driving module connector according to an embodiment of the present disclosure. FIG. 4B is a diagram showing a state in which the first connector portion of the connector connection structure of the vehicle exposes the driving module connector according to an embodiment of the present disclosure. FIG. 4C is a diagram showing a state in which the first connector portion and a second connector portion of the connector connection structure of the vehicle are being connected according to an embodiment of the present disclosure. FIG. 4D is a diagram showing a state in which the first connector portion and the second connector portion of the connector connection structure of the vehicle are completely connected according to an embodiment of the present disclosure.

Referring to FIGS. 4A to 4D, the connection auxiliary device 14 may be formed as a plurality of plates arranged along the circumference of an outer peripheral part of the other end of the driving module connector 12. The plurality of plates may have a curved rectangular shape and a concave shape toward the second connector portion 20.

The plurality of plates may be arranged so that side portions thereof overlap each other and are provided to operate in series approximately at the same time. Such a structure may be formed as, for example, a plurality of wing members (plates) connected to each other, partially overlapping, and operating in series. In other words, even if only one plate among the plurality of plates operates, the other plates overlapping the one plate may operate together in series.

The plurality of plates may be provided so that first ends thereof hinge and rotate at the outer peripheral part of the other end of the driving module connector 12. The plurality of plates may hinge and rotate about an axis that is a direction perpendicular to a longitudinal direction of a vehicle body, i.e., a short side of a rectangular plate.

As shown in FIG. 4A, in a standby state where the driving module 100 and the space module 200 are not coupled, the actuator 16 pushes and applies pressure to the side of the connection auxiliary device 14 such that the plurality of plates remain folded.

As shown in FIG. 4B, when the driving module 100 and the space module 200 approach each other, the actuator 16 operates to release the pressure applied to the connection auxiliary device 14. In this case, a bar provided on the actuator 16 retreats away from the connection auxiliary device 14, and the plurality of plates unfold by an elastic force such that the other end of the driving module connector 12 is exposed.

As shown in FIG. 4C, the driving module connector 12 is disposed at a position corresponding to the space module connector 22, and they are prepared to be connected to each other.

Then, as shown in FIG. 4D, the driving module 100 further approaches the space module 200 such that the driving module connector 12 and the space module connector 22 are connected to each other. At this time, the actuator 16 operates to contact and apply pressure to the side of the connection auxiliary device 14, and the plurality of plates are folded with the other ends inserted into the connection groove 24 formed in the space module connector 22 to be coupled and fixed. As a result, the connector connection structure of the vehicle 1000 is completed.

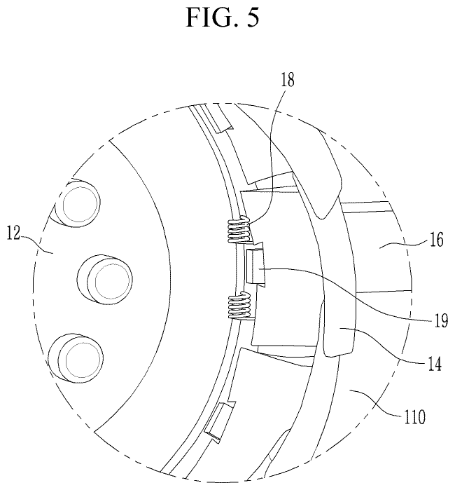

FIG. 5 is an enlarged view of the first connector portion of the connector connection structure of the vehicle according to an embodiment of the present disclosure.

Referring to FIG. 5, a center part of one end of a plurality of plates may be connected to a hinge member 19 to hinge and rotate. The plurality of plates may hinge and rotate so that the other end thereof has an operating range from a range greater than a thickness of the space module connector 22 to a range that completely covers the driving module connector 12.

In addition, elastic members 18 that provide an elastic force may be provided on both sides of the hinge member 19 to unfold the plurality of plates. The elastic members 18 may be provided on the fixing bar 110 and supported in contact with one end of the plates to apply the elastic force in a direction to unfold the plates. The elastic members 18 may be made of springs.

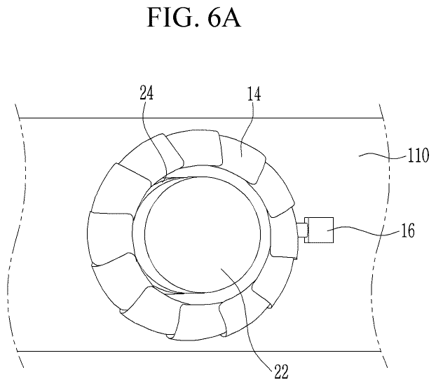

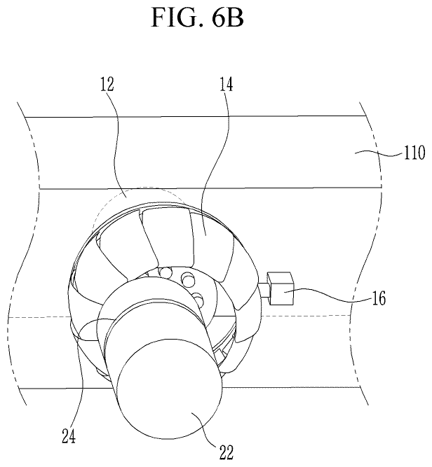

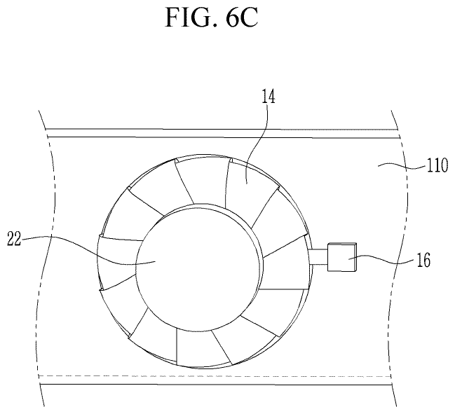

FIG. 6A is a diagram showing an example of a connection error in the connector connection structure of the vehicle according to an embodiment of the present disclosure. FIG. 6B is a diagram showing another example of a connection error in the connector connection structure of the vehicle according to an embodiment of the present disclosure. FIG. 6C is a diagram showing an example of a normal connection of the connector connection structure of the vehicle according to an embodiment of the present disclosure.

When the driving module 100 and the space module 200 are connected to each other, the driving module connector 12 and the space module connector 22 need to be connected at a correct position so that cross sections thereof match.

However, as shown in FIG. 6A, when the driving module connector 12 and the space module connector 22 are connected such that cross sections thereof do not match, a plurality of plates of the connection auxiliary device 14 do not completely cover the driving module connector 12, and the other ends of the plates are inserted into the connection groove 24. In this case, it is determined that the connection fails, the driving module 100 moves forward again and then moves backward, and repeated attempts are made until the driving module connector 12 and the space module connector 22 are connected at the correct position and the plurality of plates completely cover the driving module connector 12.

To this end, a sensor (not shown) that senses positions of the plurality of plates of the connection auxiliary device 14 may be provided in the first connector portion 10, and accordingly, a control unit (not shown) that determines whether it is the correct position may be provided. A controller may be implemented as one or more processors that operate according to a set program, and the set program may be programmed to perform a connector connection process of the vehicle 1000 according to an embodiment of the present disclosure.

As shown in FIG. 6B, when the plurality of plates of the connection auxiliary device 14 are folded in a state where the driving module connector 12 and the space module connector 22 are not connected, the other ends of the plurality of plates are not inserted into the connection groove 24, and it is determined that the connection fails.

As shown in FIG. 6C, when the driving module connector 12 and the space module connector 22 are connected at the correct position so that the cross sections thereof match, and the plurality of plates of the connection auxiliary device 14 are folded so that the other ends of the plurality of plates are inserted into the connection groove 24, it is determined that the connection is good, and thus, the connector connection process of the vehicle 1000 is completed.

As described above, according to embodiments of the present disclosure, the connector connection structure of the vehicle may automatically connect a power and communication connector at a correct position when connecting a driving module and a space module and protect the connector and a connector connection part from external contamination when disconnecting the driving module and the space module.

In addition, the connector connection structure of the vehicle may be widely employed not only for coupling PBVs, but also for connecting trailers and towing vehicles, and applied from a manual method to an automatic method, and thus, marketability may be improved.

Although preferred embodiments of the present disclosure have been described above, the present disclosure is not limited to the above embodiments, the present disclosure includes all modifications within the range easily changed and recognized as being equivalent by those of ordinary skill in the art to which the present disclosure pertains from the embodiments of the present disclosure.

The following reference identifiers may be used in connection with the drawings to describe various features of embodiments of the present disclosure.

| | |
|---|---|
| 1000: vehicle | 100: driving module |
| 200: space module | 110: fixing bar |
| 210: support | 10: first connector portion |
| 12: driving module connector | 14: connection auxiliary device |
| 16: actuator | 18: elastic member |
| 19: hinge member | 20: second connector portion |
| 22: space module connector | 24: connection groove |

What is claimed is:

1. A power and communication connector connection structure of a vehicle that comprises a driving module and a space module coupled to a rear end of the driving module, the connector connection structure comprising:
a first connector portion disposed on a fixing bar disposed at the rear end of the driving module and protruding toward the space module; and
a second connector portion disposed on a support of the space module to face the fixing bar and protruding toward the driving module at a part corresponding to the first connector portion to be coupled to or separated from the first connector portion.

2. The connector connection structure of claim 1, wherein the first connector portion comprises:
a driving module connector recessed into the fixing bar and having a first end connected to an inside of the driving module and a second end protruding toward the space module;
a connection auxiliary device disposed outside the fixing bar in a direction toward the space module and configured to operate to cover or uncover the second end of the driving module connector at an outer peripheral part of the second end of the driving module connector; and
an actuator disposed on a side portion of the connection auxiliary device outside the fixing bar and configured to apply pressure through contact with the connection auxiliary device and operate the connection auxiliary device.

3. The connector connection structure of claim 2, wherein the second connector portion comprises:
a space module connector recessed into the support and having a first end connected to an inside of the space module and a second end protruding toward the driving module; and
a connection groove disposed in an outer peripheral surface of a protruding part of the space module connector and into which an end of the connection auxiliary device is inserted and fixed.

4. The connector connection structure of claim 3, wherein:
the driving module connector is configured as a female-type (F-type) connector and the space module connector is configured as a male-type (M-type) connector; and
the driving module connector and the space module connector have a cylindrical shape.

5. The connector connection structure of claim 4, wherein the connection auxiliary device comprises a plurality of plates arranged along a circumference of the outer peripheral part of the second end of the driving module connector, and wherein the plurality of plates are arranged so that side portions thereof overlap each other and are configured to operate in series at the same time.

6. The connector connection structure of claim 5, wherein the plurality of plates have a concave shape toward the second connector portion.

7. The connector connection structure of claim 5, wherein the plurality of plates are disposed such that a first end thereof is configured to hinge and rotate around an axis that is a direction perpendicular to a longitudinal direction of the vehicle at the outer peripheral part of the second end of the driving module connector.

8. The connector connection structure of claim 7, wherein a center part of the first end of the plurality of plates is connected to a hinge member and is configured to hinge and rotate.

9. The connector connection structure of claim 8, wherein elastic members are disposed on both sides of the hinge member of the fixing bar, the elastic members being configured to provide an elastic force such that the plurality of plates are unfolded.

10. The connector connection structure of claim 5, wherein the plurality of plates are configured to hinge and rotate so that a second end thereof has an operating range from a range greater than a thickness of the space module connector to a range that completely covers the driving module connector.

11. The connector connection structure of claim 3, wherein, in a standby state in which the driving module and the space module are not coupled to each other, the actuator is configured to be in contact with and apply pressure to the connection auxiliary device to operate such that the connection auxiliary device completely covers the second end of the driving module connector.

12. The connector connection structure of claim 3, wherein, in a state in which the first connector portion is connected to the second connector portion, the actuator is configured to be in contact with and apply pressure to the connection auxiliary device to operate such that the end of the connection auxiliary device is inserted into the connection groove.

13. A vehicle comprising:
a driving module;
a space module configured to be coupled to a rear end of the driving module;
a fixing bar disposed at the rear end of the driving module;
a first connector portion disposed on the fixing bar and protruding toward the space module;
a support disposed on the space module; and
a second connector portion disposed on the support to face the fixing bar and protruding toward the driving module at a part corresponding to the first connector portion and configured to be coupled to or separated from the first connector portion.

14. The vehicle of claim 13, wherein the first connector portion comprises:
a driving module connector recessed into the fixing bar and having a first end connected to an inside of the driving module and a second end protruding toward the space module;
a connection auxiliary device disposed outside the fixing bar in a direction toward the space module and configured to operate to cover or uncover the second end of the driving module connector at an outer peripheral part of the second end of the driving module connector; and
an actuator disposed on a side portion of the connection auxiliary device outside the fixing bar and configured to apply pressure through contact with the connection auxiliary device and operate the connection auxiliary device.

15. The vehicle of claim 14, wherein the second connector portion comprises:
a space module connector recessed into the support and having a first end connected to an inside of the space module and a second end protruding toward the driving module; and
a connection groove disposed in an outer peripheral surface of a protruding part of the space module connector and into which an end of the connection auxiliary device is inserted and fixed.

16. The vehicle of claim 15, wherein:
the driving module connector is configured as a female-type (F-type) connector and the space module connector is configured as a male-type (M-type) connector; and
the driving module connector and the space module connector have a cylindrical shape.

17. The vehicle of claim 16, wherein the connection auxiliary device comprises a plurality of plates arranged along a circumference of the outer peripheral part of the second end of the driving module connector, and wherein the plurality of plates are arranged so that side portions thereof overlap each other and are configured to operate in series at the same time.

18. The vehicle of claim 17, wherein the plurality of plates are disposed such that a first end thereof is configured to hinge and rotate around an axis that is a direction perpendicular to a longitudinal direction of the vehicle at the outer peripheral part of the second end of the driving module connector.

19. The vehicle of claim 18, wherein:
a center part of the first end of the plurality of plates is connected to a hinge member and is configured to hinge and rotate; and
elastic members are disposed on both sides of the hinge member of the fixing bar, the elastic members being configured to provide an elastic force such that the plurality of plates are unfolded.

20. The vehicle of claim 15, wherein:
in a standby state in which the driving module and the space module are not coupled to each other, the actuator is configured to be in contact with and apply pressure to the connection auxiliary device to operate such that the connection auxiliary device completely covers the second end of the driving module connector; and
in a state in which the first connector portion is connected to the second connector portion, the actuator is configured to be in contact with and apply pressure to the connection auxiliary device to operate such that the end of the connection auxiliary device is inserted into the connection groove.
